(19) United States
(12) Patent Application Publication
(10) Pub. No.: US 2021/0029564 A1
(43) Pub. Date: Jan. 28, 2021

(54) USER EQUIPMENT ASSISTED LEVELING AND OPTIMIZATION OF DISTRIBUTED ANTENNA SYSTEMS

(71) Applicant: Andrew Wireless Systems GmbH, Buchdorf (DE)

(72) Inventors: Alfred Josef Lupper, Aystetten (DE); Klaus Uwe Rosenschild, Donauwörth (DE)

(73) Assignee: Andrew Wireless Systems GmbH, Buchdorf (DE)

(21) Appl. No.: 17/044,589

(22) PCT Filed: May 17, 2019
(86) PCT No.: PCT/EP2019/062778

§ 371 Date: Oct. 1, 2020

Related U.S. Application Data
(60) Provisional application No. 62/672,965, filed on May 17, 2018.

(51) Int. Cl. H04W 24/08; H04B 17/318; H04B 7/024

(52) U.S. Cl. CPC H04W 24/08; H04B 7/024; H04B 17/318

(57) ABSTRACT

In one embodiment, a method for leveling and optimizing a distributed antenna system (DAS) includes determining a position of a test user equipment (UE); identifying one or more remote antenna units (RAUs) of a plurality of RAUs of the DAS in a vicinity of the test UE that contribute to down-link test signals received by the test UE at the position; transmitting downlink test signals from each RAU of the one or more RAUs to the test UE at the position; measuring a signal power of the downlink test signals transmitted from each RAU of the one or more RAUs received by the test UE at the position; and adjusting one or more components of the DAS until a target signal power of the downlink test signals from each RAU of the one or more RAUs for the position is received at the test UE.

### CROSS-REFERENCE TO RELATED APPLICATIONS

This application claims the benefit of U.S. Provisional Application Ser. No. 62/672,965, filed May 17, 2018, and titled “USER EQUIPMENT ASSISTED LEVELING AND OPTIMIZATION OF DISTRIBUTED ANTENNA SYSTEM,” which is hereby incorporated herein by reference.

### BACKGROUND

One way that a wireless cellular service provider can improve the coverage provided by a base station or group of base stations is by using a distributed antenna system (DAS). A DAS typically comprises one or more master units and one or more remote units that are communicatively coupled to the master units either directly or indirectly via one or more intermediary units or expansion units. A DAS distributes radio frequency (RF) signals coming from a base station to the antennas of the remote antenna units in the downlink direction, and transmits the combined RF signals originating from mobile devices to the base station in the uplink direction. On their way through a DAS, the RF signals are attenuated by passive components (for example, cables, combiners, splitters) and amplified by active components (for example, power amplifiers). One type of DAS is an analog DAS, in which DAS traffic is distributed between the master units and the remote antenna units in analog form. Another type of DAS is a digital DAS, in which DAS traffic is distributed between the master units and the remote antenna units in digital form.

A DAS has to ensure that RF signals received from the base station at a given input level are radiated at the antenna at a defined output level on one hand and that signals from mobile devices are received by the base station at a certain power level on the other hand. To achieve this, attenuators and amplifiers have to be adjusted at the DAS accordingly. This process is called the leveling and optimization of the DAS.

When the DAS is commissioned, it must be shown that the DAS satisfies the radio frequency network plan, so a walk test is conducted to determine the signal level at points throughout the coverage areas of the DAS. Radio network planning generally requires a certain signal power level and signal quality at each position in the radio network. The target of the leveling and optimization is to adjust the amplifiers and attenuators of the DAS in a way that the desired signal power level and signal quality is received at a certain location according to the radio network planning. Current techniques for leveling a DAS include generating test signals and adjusting components of the DAS to produce desired output power at the remote antenna units in the downlink and to produce the desired signal power at the base station output for the uplink. Current techniques for optimizing a DAS include conducting walk tests, which include measuring the signal strength of downlink signals with a test mobile, comparing the measured signal strength to values from a radio network plan, and adjusting the attenuation and/or amplification of the DAS based on this information. With this approach, it is common for multiple iterations of the walk test to be required before a DAS is approved, which is time consuming and labor intensive for the technicians conducting the walk test.

### SUMMARY

Systems and methods for user equipment assisted leveling and optimization of a distributed antenna system are provided. In one embodiment, a method for leveling and optimizing a distributed antenna system includes determining a position of a test user equipment and identifying one or more remote antenna units of a plurality of remote antenna units of the distributed antenna system in a vicinity of the test user equipment that contribute to downlink test signals received by the test user equipment at the position. The method further includes transmitting downlink test signals from each remote antenna unit of the one or more remote antenna units to the test user equipment at the position. The method further includes measuring a signal power of the downlink test signals transmitted from each remote antenna unit of the one or more remote antenna units received by the test user equipment at the position. The method further includes adjusting one or more components of the distributed antenna system until a target signal power of the downlink test signals from each remote antenna unit of the one or more remote antenna units for the position is received at the test user equipment.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an example distributed antenna system according to an aspect of the present disclosure;

FIG. 2 is a block diagram of an example test user equipment according to an aspect of the present disclosure;

FIG. 2A is a block diagram of an example user interface for the test user equipment according to an aspect of the present disclosure;

FIG. 3 is a flow chart of an example method of leveling and optimizing the downlink of a DAS according to an aspect of the present disclosure;

FIG. 4 is a flow chart of an example method of leveling and optimizing the uplink of a DAS according to an aspect of the present disclosure;

FIG. 5 is a flow chart of an example method of leveling and optimizing the downlink of a DAS according to an aspect of the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The current techniques for leveling and optimizing a DAS are limited in that antenna loss, losses over the air interface, etc. are not considered during the leveling process and multiple iterations of the walk test and adjustment are required to establish that the DAS complies with the radio network plan. The embodiments described herein include systems and methods for user equipment assisted leveling and optimization for distributed antenna systems. For downlink leveling and optimization, the test user equipment is configured to receive and measure the signal power and/or quality of test signals from the DAS. The user equipment can provide the measurements of the test signals or commands to the DAS, and the DAS can adjust one or more components in the downlink paths of the DAS based on the communication from the user equipment. For uplink leveling and optimization, the user equipment (for example, a test mobile) generates a test signal in the uplink at a certain power level and frequency. The signal power of the uplink test signals is measured at a unit of the DAS, and the DAS can adjust one or more components in the uplink paths of the DAS based on the measurements or commands received by the DAS.

The embodiments described herein utilizing a test user equipment during DAS leveling and optimization provide a full picture of the path loss for the downlink and uplink paths from the base station interface of the DAS to the test user equipment at locations in the radio network. With the information from the test user equipment, the leveling and optimization of the DAS is more accurate than using only components within the DAS itself. The DAS can also be leveled and optimized using a single walk test rather than the multiple iterations of walk tests and adjustments required for previous systems and methods. In some examples, manual adjustments for leveling and optimization of the DAS can be implemented with a user interface of the test user equipment, which provides a user-friendly and efficient experience for a single user leveling and optimizing the DAS. In some examples, a DAS configured for multiple-input/multiple-output (MIMO) operation can be leveled using the test user equipment assisted techniques. Further, a complete heat map for the coverage area of the DAS can be generated using the test user equipment.

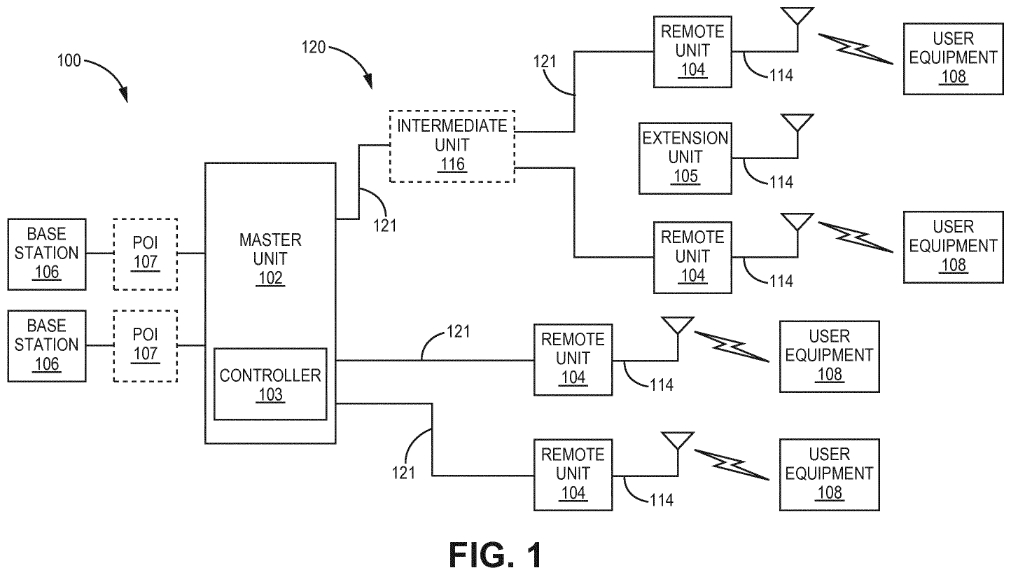

FIG. 1 is a block diagram of an example a distributed antenna system (DAS) 100 in which the leveling and optimization methods described herein can be implemented.

The DAS 100 comprises one or more master units 102 (also referred to as “central area nodes”) and one or more remote antenna units 104 (also referred to as “remote units”) that are communicatively coupled to the master units 102. In this exemplary embodiment, the DAS 100 comprises a digital DAS, in which DAS traffic is distributed between the master units 102 and the remote antenna units 104 in digital form. In other embodiments, the DAS 100 is implemented, at least in part, as an analog DAS, in which DAS traffic is distributed at least part of the way between the master units 102 and the remote antenna units 104 in analog form.

Each master unit 102 is communicatively coupled to one or more base stations 106. One or more of the base stations 106 can be co-located with the respective master unit 102 to which it is coupled (for example, where the base station 106 is dedicated to providing base station capacity to the DAS). Also, one or more of the base stations 106 can be located remotely from the respective master unit 102 to which it is coupled (for example, where the base station 106 is a macro base station providing base station capacity to a macro cell in addition to providing capacity to the DAS). In this latter case, a master unit 102 can be coupled to a donor antenna in order to wirelessly communicate with the remotely located base station 106.

The base stations 106 can be implemented as a traditional monolithic base station. Also, the base stations 106 can be implemented using a distributed base station architecture in which a base band unit (BBU) is coupled to one or more remote radio heads (RRHs), where the front haul between the BBU and the RRH uses streams of digital IQ samples. Examples of such an approach are described in the Common Public Radio Interface (CPRI) and Open Base Station Architecture Initiative (OBSAI) families of specifications.

The master units 102 can be configured to use wideband interfaces or narrowband interfaces to the base stations 106. Also, the master units 102 can be configured to interface with the base stations 106 using analog radio frequency (RF) interfaces or digital interfaces (for example, using a CPRI or OBSAI digital IQ interface). In some examples, the master units 102 interface with the base stations 106 via one or more wireless interface nodes (not shown). A wireless interface node can be located, for example, at a base station hotel, and group a particular part of a RF installation to transfer to the master unit 102.

Traditionally, each master unit 102 interfaces with one or more base stations 106 using the analog radio frequency signals that each base station 106 communicates to and from user equipment 108 (also referred to as “mobile units” or “mobile devices”) using a suitable air interface standard. The DAS operates as a distributed repeater for such radio frequency signals. RF signals transmitted from each base station 106 (also referred to herein as “downlink RF signals”) are received at one or more master units 102. Each master unit 102 uses the downlink RF signals to generate a downlink transport signal that is distributed to one or more of the remote antenna units 104. Each such remote antenna unit 104 receives the downlink transport signal and reconstructs a version of the downlink RF signals based on the downlink transport signal and causes the reconstructed downlink RF signals to be radiated from at least one antenna 114 coupled to or included in that remote antenna unit 104.

A similar process is performed in the uplink direction. RF signals transmitted from mobile units (also referred to herein as “uplink RF signals”) are received at one or more remote antenna units 104. Each remote antenna unit 104 uses the uplink RF signals to generate an uplink transport signal that is transmitted from the remote antenna unit 104 to a master unit 102. Each master unit 102 receives uplink transport signals transmitted from one or more remote antenna units 104 coupled to it. The master unit 102 combines data or signals communicated via the uplink transport signals received at the master unit 102 and reconstructs a version of the uplink RF signals received at the remote antenna units 104. The master unit 102 communicates the reconstructed uplink RF signals to one or more base stations 106. In this way, the coverage of the base stations 106 can be expanded using the DAS.

As noted above, in the exemplary embodiment shown in FIG. 1, the DAS is implemented as a digital DAS. In a “digital” DAS, signals received from and provided to the base stations 106 and mobile units 108 are used to produce digital in-phase (I) and quadrature (Q) samples, which are communicated between the master units 102 and remote antenna units 104. It is important to note that this digital IQ representation of the original signals received from the base stations 106 and from the mobile units 108 still maintains the original modulation (that is, the change in the amplitude, phase, or frequency of a carrier) used to convey telephony or data information pursuant to the cellular air interface protocol used for wirelessly communicating between the base stations 106 and the mobile units 108. Examples of such cellular air interface protocols include, for example, the Global System for Mobile Communication (GSM), Universal Mobile Telecommunications System (UMTS), High-Speed Downlink Packet Access (HSDPA), and Long-Term Evolution (LTE) air interface protocols. Also, each stream of digital IQ samples represents or includes a portion of wireless spectrum. For example, the digital IQ samples can represent a single radio access network carrier (for example, a UMTS or LTE carrier of 5 MHz) onto which voice or data information has been modulated using a UMTS or LTE air interface. However, it is to be understood that each such stream can also represent multiple carriers (for example, in a band of frequency spectrum or a sub-band of a given band of frequency spectrum).

In the example shown in FIG. 1, one or more of the master units 102 are configured to interface with one or more base stations 106 using an analog RF interface (for example, either a traditional monolithic base station or via the analog RF interface of an RRH). The base stations 106 can be coupled to the master units 102 using a network of attenuators, combiners, splitters, amplifiers, filters, cross-connects, etc., which is referred to collectively as a point-of-interface (POI) 107. This is done so that, in the downstream, the desired set of RF carriers output by the base stations 106 can be extracted, combined, and routed to the appropriate master unit 102, and so that, in the upstream, the desired set of carriers output by the master unit 102 can be extracted, combined, and routed to the appropriate interface of each base station 106.

In the exemplary embodiment shown in FIG. 1, in the downstream, each master unit 102 can produce digital IQ samples from an analog wireless signal received at radio frequency (RF) by down-converting the received signal to an intermediate frequency (IF) or to baseband, digitizing the down-converted signal to produce real digital samples, and digitally down-converting the real digital samples to produce digital in-phase (I) and quadrature (Q) samples. These digital IQ samples can also be filtered, amplified, attenuated, and/or re-sampled or decimated to a lower sample rate. The digital samples can be produced in other ways. Each stream of digital IQ samples represents a portion of wireless radio frequency spectrum output by one or more base stations 106. Each portion of wireless radio frequency spectrum can include, for example, a band of wireless spectrum, a sub-band of a given band of wireless spectrum, or an individual wireless carrier.

Likewise, in the upstream, each master unit 102 can produce an upstream analog wireless signal from one or more streams of digital IQ samples received from one or more remote antenna units 104 by digitally combining streams of digital IQ samples that represent the same carriers or frequency bands or sub-bands (for example, by digitally summing such digital IQ samples), digitally up-converting the combined digital IQ samples to produce real digital samples, performing a digital-to-analog process on the real samples in order to produce an IF or baseband analog signal, and up-converting the IF or baseband analog signal to the desired RF frequency. The digital IQ samples can also be filtered, amplified, attenuated, and/or re-sampled or interpolated to a higher sample rate, before and/or after being combined. The analog signal can be produced in other ways (for example, where the digital IQ samples are provided to a quadrature digital-to-analog converter that directly produces the analog IF or baseband signal).

In the exemplary embodiment shown in FIG. 1, one or more of the master units 102 can be configured to interface with one or more base stations 106 using a digital interface (in addition to, or instead of) interfacing with one or more base stations 106 via an analog RF interface. For example, the master unit 102 can be configured to interact directly with one or more BBUs using the digital IQ interface that is used for communicating between the BBUs and an RRHs (for example, using the CPRI serial digital IQ interface).

In the downstream, each master unit 102 terminates one or more downstream streams of digital IQ samples provided to it from one or more BBUs and, if necessary, converts (by re-sampling, synchronizing, combining, separating, gain adjusting, etc.) them into downstream streams of digital IQ samples compatible with the remote antenna units 104 used in the DAS. In the upstream, each master unit 102 receives upstream streams of digital IQ samples from one or more remote antenna units 104, digitally combining streams of digital IQ samples that represent the same carriers or frequency bands or sub-bands (for example, by digitally summing such digital IQ samples), and, if necessary, converts (by re-sampling, synchronizing, combining, separating, gain adjusting, etc.) them into upstream streams of digital IQ samples compatible with the one or more BBUs that are coupled to that master unit 102.

In the downstream, each remote antenna unit 104 receives streams of digital IQ samples from one or more master units 102, where each stream of digital IQ samples represents a portion of wireless radio frequency spectrum output by one or more base stations 106.

In some aspects, the master units 102 are directly coupled to the remote antenna units 104. In such aspects, the master units 102 are coupled to the remote antenna units 104 using a communication medium 121. For example, the communication medium 121 can include optical fiber or Ethernet cable complying with the Category 5, Category 5e, Category 6, Category 6A, or Category 7 specifications. Future communication medium specifications used for Ethernet signals are also within the scope of the present disclosure.

In some aspects, one or more intermediate units 116 (also referred to as “expansion units” or “transport expansion nodes”) can be placed between the master units 102 and one or more of the remote antenna units 104. This can be done, for example, in order to increase the number of remote antenna units 104 that a single master unit 102 can feed, to increase the master-unit-to-remote-antenna-unit distance, and/or to reduce the amount of cabling needed to couple a master unit 102 to its associated remote antenna units 104. The expansion units 116 are coupled to the master unit 102 via one or more communication links 121. In exemplary embodiments, the communication links includes optical communication links or other wired communication medium.

In the example DAS 100 shown in FIG. 1, a remote antenna unit 104 is shown having another remote antenna unit 105 (also referred to herein as an “extension unit”) communicatively coupled to it in a daisy chain. In operation, the remote antenna units 104, 105 could be used for MIMO transmissions, for example. The remote antenna unit 104 is communicatively coupled to the remote antenna units 105 using a fiber optic cable, a multi-conductor cable, coaxial cable, or the like could be used. In such an implementation, the remote antenna units 105 are coupled to the master unit 102 of the DAS 100 via the remote antenna unit 104.

In various aspects, system elements, method steps, or examples described throughout this disclosure (such as the master unit, expansion units, remote antenna units, user equipment, or components thereof, for example) may be implemented on one or more computer systems, field programmable gate array (FPGA), application specific integrated circuit (ASIC) or similar devices comprising hardware executing code to realize those elements, processes, or examples, said code stored on a non-transient data storage device. These devices include or function with software programs, firmware, or other computer readable instructions for carrying out various methods, process tasks, calculations, and control functions, used for synchronization and fault management in a distributed antenna system.

These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk - Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

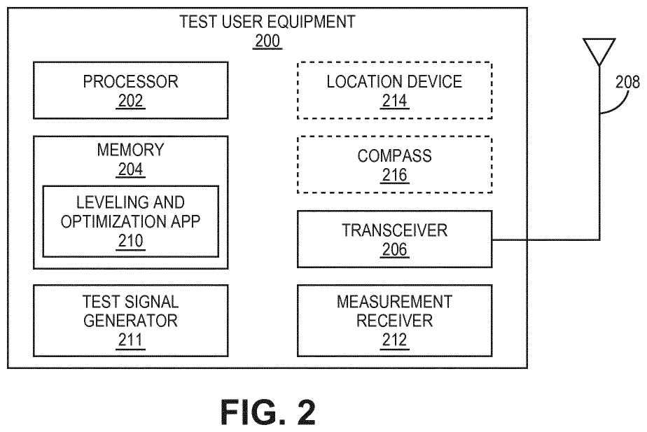

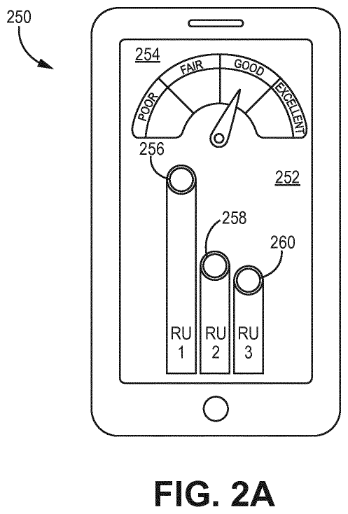

FIG. 2 is a block diagram of an example test user equipment 200 according to the present disclosure. The test user equipment 200 is utilized during leveling and optimization of a DAS. The functions, structures, and other description of the test user equipment for such examples described herein may apply to test user equipment 200 and vice versa.

In the example shown in FIG. 2, the test user equipment includes one or more processors 202 in communication with a memory device 204, a transceiver device 206, an antenna 208, and a measurement receiver 212. If the test user equipment is used for uplink leveling and optimization, the test user equipment 200 also includes a test signal generator 211. In some examples, the test user equipment optionally includes a location device 214 and/or a compass 216. Instructions, such as the leveling and optimization application 210, can be stored in the memory device 204 as executable code. In some examples, the test user equipment 200 stores radio network planning information for desired signal power and signal quality values for each location throughout the radio network in memory 204. For example, the radio network planning information could include a database of locations and corresponding desired signal power and signal quality for each location. The radio network planning information can also include a location of each of the remote antenna units and extension units that are in the radio network.

The transceiver device 206 is configured to communicate wireless signals with units of the DAS and particularly communicates test signals. The transceiver device 206 is also configured to communicate measurement information, commands, or other signals related to the leveling and optimization of the DAS with a controller of the DAS.

The measurement receiver 212 is configured to determine signal levels and/or quality for test signals received by the transceiver device 206. The one or more processors 202 can obtain the test signal levels from the measurement receiver 212 and generate measurement data based on the test signal levels obtained from the measurement receiver 212. The measurement data can include data that describes the signal strength and/or signal quality of particular test signals received by the transceiver device 206.

In some examples, the test user equipment 200 includes a location device 214 configured to provide information that can be used to determine the position of the test user equipment 214. In some examples, the location device 214 is an accelerometer, a GNSS device, or other similar devices that enable determination of the position of the test user equipment 200.

In some examples, the test user equipment also includes a compass 216 or similar device to provide information regarding the direction or orientation of the test user equipment. Information regarding the direction or orientation of the test user equipment can aid in determining from which remote antenna unit a signal should be received. For example, a determination can be made regarding whether the remote antenna unit providing the signals to the test user equipment is on the right or the left side of the test user equipment.

In the example shown in FIG. 2, the test user equipment 200 includes a leveling and optimization application 210 stored in the memory device 204, which can implement functionality described herein when executed by the one or more processors 202. The instructions can include processor-specific instructions generated by a compiler and/or an interpreter from code written in any suitable computer-programming language. The leveling and optimization application 210, which can be executed by a user for optimizing the DAS, uses the measurement data obtained from the measurement receiver 212 or from a unit of the DAS. In some examples, the one or more processors 202 provide the measurement data to the DAS. In some examples, the one or more processors 202 provide commands to a controller of the DAS for making adjustments to one or more components in a signal path of the DAS based on the measurement data.

For leveling and optimization of the downlink, the one or more processors 202 of the test user equipment 200 can execute the leveling and optimization application 210 to send the measured signal power and/or signal quality levels for particular locations of the test user equipment 200. The information can be sent in a control plane (for example, a WLAN connection or suitable protocol with access to the control plane) or in an uplink band of the DAS to the master unit 102 or DAS controller 103. The DAS is configured to adjust one or more components in the downlink signal paths of the DAS to achieve the desired signal power and/or signal quality at the particular location of the test user equipment 200 according to the radio network plan. For example, the controller 103 of the DAS can receive the measurement data from the test user equipment 200 and calculate an optimized value for the output of the remote antenna unit to provide the desired signal strength and/or signal quality. In such an example, the controller 103 of the DAS adjusts the output power of a remote antenna unit by modifying a power amplifier and/or one or more variable attenuators of the remote antenna unit. In other examples, the test user equipment 200 compares the measured signal power and/or quality levels with the desired signal power and/or quality levels. In such examples, the test user equipment 200 provides commands to the DAS controller 103 to perform the adjustments based on the comparison.

For leveling and optimization of the uplink, the test user equipment 200 can generate test tones or other test signals using the test signal generator 211. The transceiver device 206 of the test user equipment 200 can transmit the test signals in the uplink band of the DAS and the remote antenna units receive the uplink test signals. The measurement receiver 212 can measure the initial signal power of a test signal transmitted by the test user equipment 200 for comparison purposes or the test signal generator 211 can include this functionality.

In some aspects, the one or more processors 202 of the test user equipment 200 execute the leveling and optimization application 210 during the walk test to conduct measurement of test signals and adjusting components of the DAS.

In some aspects, the test user equipment 200 is configured to collect and display the measurement data in real-time or near real-time. Collecting and displaying measurement data in real-time can include, for example, defining or otherwise identifying an interval of time and collecting and displaying the measurement data within the time interval. Displaying the measurement data in real-time can allow for the DAS to be configured via a user interface during a walk test for optimizing the DAS.

FIG. 2A is a block diagram of an example user interface 250 of test user equipment 200 according to an aspect of the present disclosure. In some examples, the test user equipment 200 includes a touch screen interface to provide input to the user interface 250. In other examples, the user interface 250 receives input from a user via a keyboard or other device. The functions, structures, and other description of the user interface described herein may apply to user interface 250 and vice versa.

In some aspects, the measurement data collected by the measurement receiver 212 can be used for manual leveling and optimization of the DAS using the user interface 250. In the example shown in FIG. 2A, the user interface 250 displays the measured signal power of downlink test signals from each remote antenna unit in the vicinity of the test user equipment for a current location of the test user equipment. In some examples, the user interface 250 includes the target total or composite signal power and the measured total or composite signal power for a particular location side-by-side. In some examples, the user interface 250 includes the desired signal power for downlink signals from a respective remote antenna unit and the measured signal power of downlink test signals from the respective remote antenna unit for a particular location side-by-side.

In the example shown in FIG. 2A, the user interface 250 includes multiple panes 252, 254 that include different information. The user interface 250 indicates that three remote antenna units (RU1, RU2, RU3) are in the vicinity of the test user equipment and the downlink test signals from RU1 has the highest signal power. In one embodiment, the first pane 252 includes the signal power and the second pane 254 includes a measure of signal quality. In another embodiment, the first pane 252 includes the signal power and the second pane 254 includes an indication of how the total signal power or individual signal power for a selected remote antenna unit corresponds to the target total signal power or target individual signal power, respectively.

In some examples, a user can input a command to adjust a transmitted signal power for a respective remote antenna unit by selecting a respective marker 256, 258, 260 and dragging it up or down on the user interface 250. In some examples, a user can input a command to adjust a transmitted signal power for a respective remote antenna unit by tapping a respective marker 256, 258, 260 and tapping a point on the screen above or below the marker. In response to the user input, the test user equipment 200 can send a command to the master unit or controller of the DAS and one or more components are adjusted to effect the desired change. In some examples, a save configuration button is included and selected prior to the command being sent to the DAS.

In some aspects, the test user equipment 200 can execute the leveling and optimization application 210 to generate control information describing a configuration or change in the configuration of the distributed antenna system. The control information can be transmitted in a control plane to a master unit 102 or a DAS controller 103. The control information can include commands to modify the uplink and/or downlink path gain based on an input at the user interface of the test user equipment. The DAS can be automatically configured based on the control information.

A user can also select a particular remote antenna unit to transmit downlink test signals at a particular time or select an uplink path for testing using the user interface of the test user equipment. For example, a user can choose the remote antenna unit from a menu and the selection causes a command to be sent to the DAS to open the signal path for the selected remote antenna unit and close other signal paths.

In some aspects, the test user equipment 200 is configured to generate a heat map based on the measurement data and the location of the test user equipment. The test user equipment 200 can correlate measured signals levels with positions on a floor plan or other schematic depicting or otherwise describing the coverage area serviced by the DAS 100. For example, the correlation between measured signal levels and locations in the coverage area can be performed in response to a user input received via a user interface of the test user equipment 200. For example, the test user equipment 200 can include a touch screen or keyboard. In some examples, the user can push a button and the test user equipment 200 determines its position (for example, using the location device 214), takes a measurement of the signal levels, and updates the heat map accordingly. In other examples, the user can determine the location of the test user equipment and indicate the location by tapping or providing another input to the touch screen that can cause the one or more processors 202 to mark the corresponding position on the floor plan. In some examples, the test user equipment 200 is also configured to send the generated heat map to the DAS (for example, the controller of the DAS). In such examples, the test user equipment 200 can be configured to upload a 3D heat map file in a suitable format to the controller of the DAS.

In some examples, the test user equipment 200 used for downlink leveling and optimization of the DAS is different than the test user equipment for uplink level of the DAS. For example, if signals from the base station are used as the downlink test signals, a standard mobile device with a leveling and optimization application may be used. However, using a standard mobile device would present difficulties for uplink leveling and optimization since the DAS is separate from the base station and measurements cannot be taken at the base station. For uplink leveling and optimization, the test user equipment generates a test tone at an initial signal level and frequency and the test tone is measured at a unit of the DAS (for example, the POI or master unit). If test tones are used in the downlink as well as the uplink, then the same test user equipment could be used if it is configured to receive test tones from the DAS and contains a test tone generator.

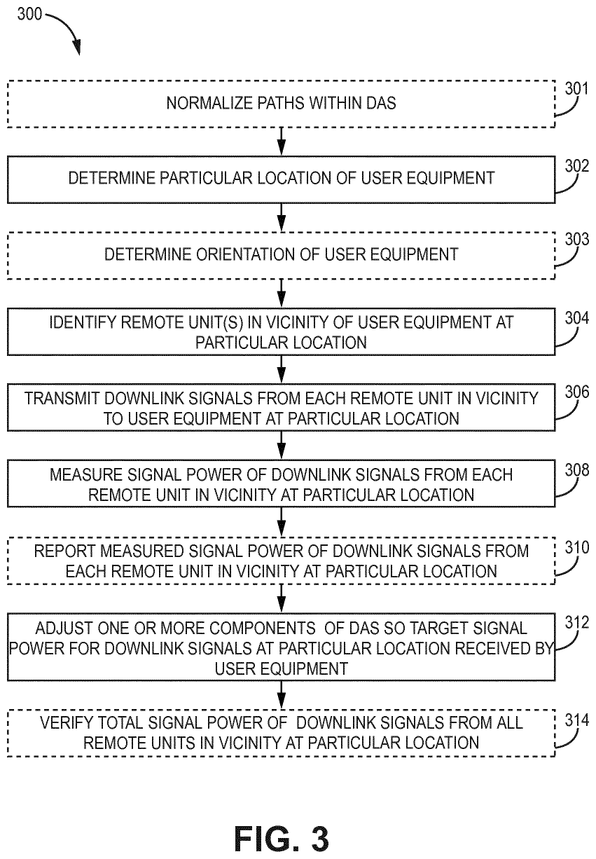

FIG. 3 is a flow chart of an example method 300 of leveling and optimization the downlink direction of a DAS that includes remote antenna units configured for single-input single-output (SISO) operation. The functions, structures, and other description of elements for such examples described herein may apply to like named elements of method 300 and vice versa.

The method 300 optionally begins with normalizing the downlink paths within the DAS (block 301). In the downlink, the normalization process includes normalizing the outputs of the master units and remote antenna units of the DAS using test signals. In some examples, normalizing the output of the master unit includes generating downlink test signals at a point of interface (POI) and adjusting the gain on the downlink path between the POI and the optical transceivers of the master unit until the power of the downlink test signals at the optical transceivers is the same. In some examples, adjusting the gain on the path between the POI and the optical transceiver includes either increasing the gain with one or more active components of the master unit or attenuating the gain with one or more attenuators in the downlink path of the master unit. This process is repeated for each downlink path between a respective POI and an optical transceiver.

In some examples, normalizing the output of the remote antenna units includes generating downlink test signals at a point of interface (POI) and adjusting the gain on the downlink path between the POI and the remote antenna unit output until the power of the downlink test signals at the outputs of the remote antenna units are the same. In some examples, normalizing the output of the remote antenna units of the DAS includes measuring the loss or gain on the downlink path between a POI (or master unit) and an output of the remote antenna unit (for example, an antenna socket) and adjusting the gain of the power amplifier at the output of the remote antenna unit. In some examples, the loss or gain on the path between the POI and the output of the remote antenna unit is measured by differencing the known power level of a test signal generated by the POI and the measured power level of the test signal at the output of the remote antenna unit. In some examples, adjusting the gain on the path between the POI and the remote antenna unit includes either amplifying the downlink signal with one or more active components of the master unit or attenuating the downlink signal with one or more attenuators in the downlink path of the master unit.

For a mobile radio network, it is important that the uplink path in a DAS has the same gain/loss as the corresponding downlink path since a user equipment communicating with the base station does not have knowledge of the DAS during normal operation. It is also important that the DAS be transparent in that uplink signals from all user equipment are received by the base station at a power level expected without the DAS. Therefore, in the uplink, the normalization process includes generating uplink test signals at the remote antenna units and normalizing the power level of the uplink test signals at the input to the base station by adjusting one or more components in the uplink path. The normalization process further includes equalizing the uplink gain/loss for respective uplink paths with the downlink gain/loss for corresponding downlink paths.

In some examples, equalizing the uplink gain/loss the output of the remote antenna units of the DAS includes measuring the loss or gain on the uplink path between an output of the remote antenna unit (for example, an antenna socket) and a POI (or master unit) and adjusting attenuators and amplifiers in the uplink path. In some examples, the loss or gain on the uplink path between the output of the remote antenna unit and the POI (or master unit) is measured by differencing the known power level of a test signal generated at the remote antenna unit and the measured power level of the test signal at the POI. In some examples, adjusting the gain on the path between the remote antenna unit and the POI (or master unit) includes either amplifying the uplink signal with one or more active components of the master unit or attenuating the uplink signal with one or more attenuators in the uplink path of the master unit.

In some examples, the adjustment of the one or more components in the uplink path is performed by the controller of the DAS or an external computer. In some examples, the adjustment is iterative and made based upon an improvement of the root mean square (RMS) or other analytical function that provides a measure of quality of the radio network coverage quality in the designated area. In such examples, the RMS or other analytical function is calculated based on the uplink path loss/gain values and the corresponding set of downlink path loss/gain values for the particular paths of the DAS.

The method 300 proceeds with determining the particular location of the test user equipment (block 302). As discussed above, it is important that the test user equipment knows its exact position for a radio network walk test. The location of the test user equipment can be determined by the test user equipment itself or by the DAS. In some examples, the position of the test user equipment is determined using a location device, such as a Global Navigation Satellite System (GNSS) device included in the test user equipment that is configured to use signals from one or more constellations (for example, GPS, GLONASS, Galileo, BeiDou). In some examples, the test user equipment position can be determined based on signal intersection measuring the received signal power compared to emitted signal power from different remote antenna units. In some examples, the test user equipment position can be determined using the runtime and strength of an RF signal received from different base stations or remote antenna units. In some examples, the test user equipment position can be determined manually on a map by a user entering the position via a user interface. In some examples, methods to determine the distances from the remote antenna units based on runtime and signal strength of laser, ultra sound, light, or the like. Optical and photogrammetric methods could also be used to determine the position of the test user equipment. In some examples, additional methods to determine location of the test user equipment for applications that are inside a building or tunnel can include using a Bluetooth beacon transmitter or other node with a known fixed position.

The method 300 optionally proceeds with determining the orientation of the test user equipment (block 303). In some examples, the test user equipment includes a compass or similar device to determine the orientation of the test user equipment.

The method 300 proceeds with identifying one or more remote antenna units in the vicinity of the particular position of the test user equipment (block 304). The remote antenna units are identified based on the radio network planning information, which indicates where the remote antenna units are positioned in the radio network. For example, the remote antenna units in the vicinity of the particular position of the test user equipment can be identified by calculating the distance from the known position of the remote antenna units (known from radio network planning) and the particular position of the test user equipment. Further, in some examples, the orientation of the test user equipment is also used to identify the one or more remote antenna units.

For optimal SISO operation, the downlink signals received at the user equipment would only be transmitted by a single remote antenna unit and there would be minimal overlap in coverage areas for remote antenna units. However, under normal operating conditions, the RF signal received by user equipment is sent from multiple remote antenna units. It is generally important that a majority of the received signal power at a particular position be from one remote antenna unit and significantly less signal power is received from neighboring remote antenna units. In some examples, only the closest remote antenna unit to the particular location of the test user equipment is identified since the closest remote antenna unit will have the highest signal contribution that needs to be optimized for a particular location.

The method 300 proceeds with transmitting downlink test signals from the one or more identified remote antenna units in the vicinity of the test user equipment at the particular location (block 306). In some examples, the downlink test signals are test tones generated by a test signal generator that is integrated into a component of the DAS (such as, for example, the POI or master unit) and transmitted to the test user equipment by the one or more identified remote antenna units. In other examples, the downlink test signals include signal traffic or a pilot channel from a base station signal that are obtained by the DAS from the base station.

The signal power received by user equipment is the composite power of the signals from multiple remote antenna units, even in a non-MIMO context. In order to better optimize each remote antenna unit, downlink test signals from the remote antenna units are transmitted individually in a single frequency band in order to distinguish the signals from different remote antenna units. In some examples, the distributed antenna system is configured to close all downlink signal paths from the unit generating the test signal (for example, the POI) and sequentially open and close respective downlink signal paths so only one remote antenna unit is transmitting at a time. In some examples, the leveling and optimization application of the test user equipment includes functionality that enables a user to select the respective downlink signal paths to open and close via a user interface of the test user equipment.

The method 300 proceeds with measuring the signal power of downlink test signals received by the test user equipment from a remote antenna unit (block 308). In some examples, the test user equipment measures the signal power of the downlink test signals using a measurement receiver (such as, for example, measurement receiver 212). In some examples, the measurement receiver determines a received signal strength indicator (RSSI), a reference signal receive power (RSRP), or the like for the received downlink test signals from the one or more remote antenna units of the DAS.

The method 300 optionally proceeds with reporting the measured signal power of the downlink test signals received by the test user equipment at the particular location (block 310). In some examples, the test user equipment is configured to report the signal power measurements to a controller of the DAS. In some examples, the test user equipment can report the signal power measurements by uploading a file in a suitable file format (for example, XML, HDF5, or 3D heat map) or data stream. In other examples, the signal power measurements can be reported to the DAS (for example, a controller of the DAS) by manually entering the signal power measurements using a graphical user interface application. It should be understood that other types of data transfer from the test user equipment to the DAS could also be used. In some examples, the test user equipment is configured to display the measured signal power of the downlink test signals via a user interface of the test user equipment.

In some examples, information regarding the orientation of the test user equipment is sent along with the measured signal powers and the location information. For example, the test user equipment may make multiple measurements of the downlink test signal power at different orientations for a particular location. In such examples, the orientation information is provided to the DAS in a similar manner to the measured signal power and the location information.

The method 300 proceeds with adjusting one or more components of the DAS until the target signal level of the downlink test signals is received at the test user equipment for the particular position (block 312). The target (desired) signal power of the downlink test signals for the particular position of the test user equipment is obtained from the radio network planning for the DAS. The target signal power for each respective remote antenna unit at a particular location can be calculated by using the target total signal power at the particular location, the output power characteristics of the remote antenna unit, and the distance between the respective remote antenna unit and the particular location. The respective target signal power for signals can be calculated using the inverse square law and the incoherent sum formula for signals.

In some examples, the controller of the DAS automatically adjusts a component of the remote antenna unit or another unit of the DAS based on a leveling algorithm incorporating the measurements from the test user equipment. In other examples, the controller adjusts one or more components of the DAS based on user input at a graphical user interface of the DAS or the test user equipment.

In some examples, the measured signal power of the downlink test signals received by the test user equipment from the remote antenna unit is compared to the target value at a particular position for the test user equipment. In some examples, the controller of the DAS compares the measured signal power of the downlink test signals received by the test user equipment to the desired signal power of the downlink test signals for the particular position of the test user equipment. In other examples, a user can compare the measured signal power of the downlink test signals at the particular position to the target value of the signal power of the downlink test signals at the particular position via a user interface of the DAS or test user equipment.

In some examples, the adjustment of the one or more components in the downlink path is performed by the controller of the DAS or an external computer. In some examples, the adjustment is iterative and made based upon an improvement of the root mean square (RMS) or other analytical function that provides a measure of the radio network coverage quality in the designated area. In such examples, the RMS or other analytical function is calculated based on the desired signal power of the downlink test signals and calculated signal power values for the downlink test signal at the particular position of the test user equipment. In some examples, the calculated signal power values for the downlink test signal at the particular position of the test user equipment is determined based on the measured signal power of the downlink test signal at the particular position of the test user equipment and a linear relationship between the adjusted DAS component settings and the measured signal power of the downlink test signal at the particular position of the test user equipment.

In some examples, the adjustment of the one or more components in the downlink path is performed using a feedback loop to optimize or improve the RMS values at particular locations. In some examples, the reference input for the controller of the feedback loop is the target RMS values for particular locations. In such examples, the current RMS value is measured at the particular locations and this information is provided to the controller of the feedback loop, which modifies values for amplifiers and attenuators in the DAS based on a mathematical function or methods of artificial intelligence in order to adjust the RMS value at the particular locations. In some examples, the optimization or improvement using the feedback loop continues until the target RMS values for the particular locations are actually achieved. In some examples, the optimization or improvement using the feedback loop continues until the current RMS values at the particular locations are within a threshold of the target RMS values for the particular locations. It should be understood that other analytical functions that provide a measure of the radio network coverage quality in a designated area could also be used for the feedback loop.

The method 300 optionally proceeds with verifying the total signal power received by the test user equipment at the particular location from all remote antenna units (block 314). In some examples, verifying the total signal power includes opening the downlink paths for all of the remote antenna units in the vicinity of the particular location and providing downlink test signals simultaneously from all of the remote antenna units in the vicinity of the particular location of the test user equipment. The total signal power is measured by the test user equipment and compared to the target total signal power from the radio network planning. When the total signal power corresponds to the target total signal power from the radio network planning, the downlink leveling and optimization for the particular location of the test user equipment is complete. When the total signal power does not correspond to the target total signal power, one or more remote antenna units can be optimized again.

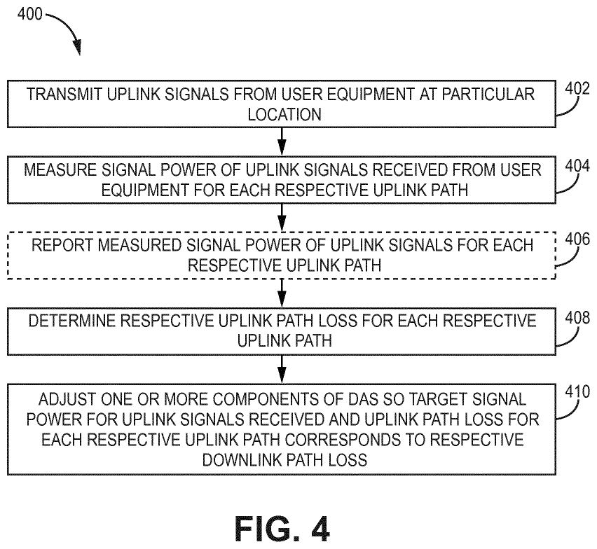

Upon completion of the downlink leveling and optimization method 300 for a particular location, uplink leveling and optimization is performed for the particular location. FIG. 4 is a flow chart of an example method 400 of leveling and optimizing a DAS operating in single-input single-output (SISO) configuration in the uplink direction. The functions, structures, and other description of elements for such examples described herein may apply to like named elements of method 400 and vice versa.

The method 400 begins with transmitting uplink test signals from the test user equipment at the particular location (block 402). In some examples, the uplink test signals transmitted by the test user equipment are generated test tones (for example, continuous wave tones), which are generated by a test signal generator (such as, for example, test signal generator 211). The test tone can be transmitted in the frequency band used by the base station or a different frequency band. In either scenario, the remote antenna units of the distributed antenna system are configured to receive signals from the test user equipment at the particular frequency used by the test user equipment.

The transmitted uplink test signals are received by remote antenna units in the vicinity of the test user equipment. The received uplink signal from the test user equipment traverse a respective uplink signal path to a unit of the distributed antenna system that is coupled to a base station or other RF source. In some examples, the unit of the distributed antenna system is a POI or master unit of the distributed antenna system.

In order to better optimize each remote antenna unit, the uplink signal paths for the remote antenna units are individually opened so the uplink test signals for respective uplink paths can be distinguished. In some examples, the distributed antenna system is configured to close all uplink signal paths from the remote antenna units to the upstream unit (for example, the POI) and sequentially open respective uplink signal paths so uplink test signals are received from a single uplink path at a time. In some examples, the leveling and optimization application of the test user equipment includes functionality that enables a user to select the respective uplink signal paths to open and close via a user interface of the test user equipment.

The method 400 proceeds with measuring the signal power of the uplink test signals from the test user equipment at the particular position for each respective uplink path (block 404). When a POI is not used, the signal power of the uplink test signals is measured at the master unit (such as master unit 102). In other examples where a POI is used, the signal power of the uplink test signals is measured at the POI. In either scenario, the master unit and the POI include one or more power measurement devices (such as, for example, a measurement receiver) communicatively coupled to the uplink signal paths and the one or more power measurement devices are configured to measure the power of the uplink test signals generated by the test user equipment. In some examples, the upstream unit measures the signal power of the uplink test signals using a measurement receiver. In some examples, the measurement receiver determines a received signal strength indicator (RSSI), a reference signal receive power (RSRP), or the like for the received uplink test signals from the test user equipment.

The method optionally proceeds with reporting the measured signal power of the uplink test signals for each respective uplink path (block 406). In some examples, the measured signal power of the uplink signals is reported to the test user equipment, and the test user equipment is configured to display the measured signal power of the uplink test signals via a user interface of the test user equipment. In some examples, the signal power of the uplink test signals is reported to a user interface of the DAS itself or a computing device communicatively coupled to the DAS.

The method proceeds with determining the respective uplink path loss for each respective uplink path from the test user equipment to the unit of the DAS (block 408). The uplink path loss is determined by subtracting the measured signal power of the uplink test signals from the initial signal power of the test signal generated by the test user equipment. The initial signal power of the test signal is measured in the test user equipment. For example, the initial signal power can be measured within the test signal generator or by a measurement receiver in the test user equipment. In other examples, the initial signal power is calculated based on the known particular location of the test user equipment and the received signal power at the remote antenna unit of the distributed antenna system. In some examples, the uplink path loss also includes the estimated cable loss from the POI or master unit to the base station, if applicable, so the total uplink path loss for normal operation is considered.

The method proceeds with adjusting one or more components of each respective uplink path of the DAS until the desired uplink signal power is received at the POI or master unit for the respective uplink path and the loss/gain on the respective uplink path and a corresponding downlink path between the base station to the test user equipment are the same (block 410). In some examples, the controller of the DAS adjusts an amplifier or attenuator of a unit of the DAS in the uplink path based on the comparison between the measured signal power for the uplink signals and the target signal power of the uplink signals. In some examples, the controller of the DAS adjusts an amplifier or variable attenuator of a unit of the DAS based on a user manually adjusting the gain/attenuation of the uplink path via a graphical user interface of the DAS or the test user equipment. For example, a user may adjust the gain/attenuation of the uplink path and the controller of the DAS adjusts one or more components in the uplink path based on user adjustments.

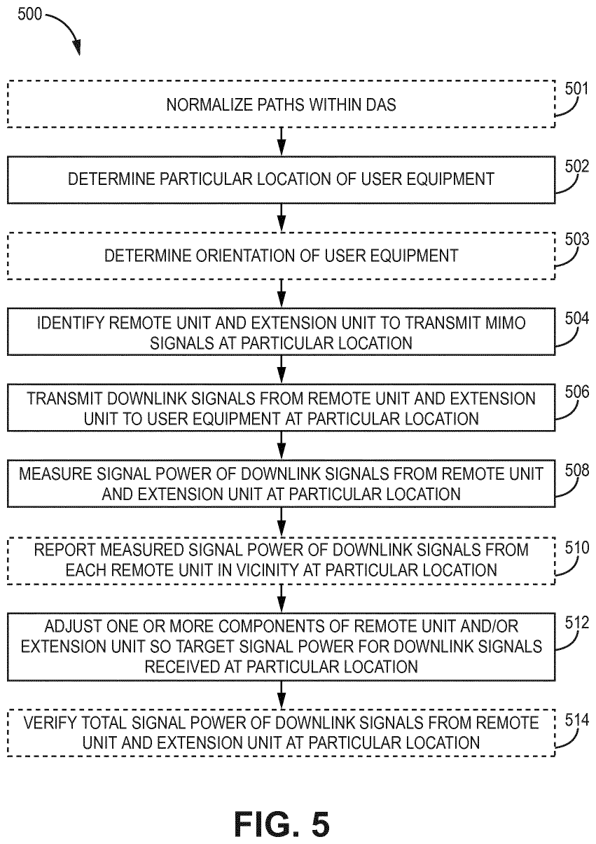

In order to improve bandwidth and data-transfer speed compared to remote antenna units configured for single-input-single output (SISO) operation, it can be desirable to incorporate multiple-input-multiple-output (MIMO) capability into remote antenna units of a distributed antenna system. FIG. 5 is a flow chart of an example method 500 of leveling and optimization the downlink direction of a DAS that includes remote antenna units configured for multiple-input-multiple-output (MIMO) operation. The functions, structures, and other description of elements for such examples described herein may apply to like named elements of method 500 and vice versa.

There is overlap in the downlink leveling and optimization process for a DAS including MIMO configured remote antenna units compared to the leveling and optimization process for a DAS including SISO configured remote antenna units. Similar to method 300, method 500 optionally begins with normalizing the paths within the DAS (block 501). The normalization process for a MIMO configuration is similar to that described above with respect to block 301 of FIG. 3 and the outputs of the extension units are normalized as well. Also similar to method 300, the method 500 proceeds with determining the particular location of the test user equipment (block 502) and optionally proceeds with determining the orientation of the test user equipment (block 503). The determination of the location of the test user equipment and optional determination of the orientation of the test user equipment is similar to that described above with respect to blocks 302-303 of FIG. 3.

Generally, only a single pair or quadruple of a remote antenna unit and extension unit should have a substantial signal strength for a particular location of the test user equipment. The method 500 proceeds with identifying a remote antenna unit and extension unit configured to transmit MIMO signals in the vicinity of the particular position of the test user equipment (block 504). In some examples, the remote antenna unit and extension unit are identified based on the radio network planning information, which indicates the transmission capabilities of the remote antenna unit and the extension unit and their positions in the radio network. For example, the remote antenna unit and extension unit can be listed as configured for MIMO and can be identified as in the vicinity of the particular location of the test user equipment by calculating the distance between the known position of the remote antenna unit and extension unit and the particular position of the test user equipment.

The method 500 proceeds with transmitting downlink test signals from the remote antenna unit and the extension unit to the test user equipment at the particular location (block 506). In some examples, the downlink test signals are test tones generated by a test signal generator that is integrated into a component of the DAS (such as, for example, the POI or master unit) and transmitted to the test user equipment by the remote antenna unit and extension unit. In other examples, the downlink test signals are signal traffic or a pilot channel from a base station signal that are obtained by the DAS from the base station.

For MIMO operation, the signals received by the user equipment are sent from a remote antenna unit and one or more extension units, and the signals are sent with the same frequency but different polarization to create the separate MIMO paths. In some examples, the test downlink signals from the one remote antenna unit and extension unit are individually transmitted to the test user equipment. In some examples, the distributed antenna system is configured to close all downlink signal paths from the unit generating the test signal (for example, the POI) and sequentially open respective downlink signal paths so only one remote antenna unit is transmitting at a time.

In some examples, the test user equipment is configured to receive and measure the signal power of multiple downlink test signals simultaneously since different polarizations can be used for the test signals. In such examples, the test user equipment includes multiple antennas and filters the test signals so the signal power of each respective test signal can be measured.

The method 500 proceeds with measuring the signal power of downlink test signals received by the test user equipment from the remote antenna unit and extension unit (block 508). The test user equipment measures the signal power of the downlink test signals using a measurement receiver (such as, for example, measurement receiver 212). In some examples, the measurement receiver determines a received signal strength indicator (RSSI), a reference signal receive power (RSRP), or the like for the received downlink test signals from the remote antenna units of the DAS.

The method 500 optionally proceeds with reporting the measured signal power of the downlink test signals received by the test user equipment from the remote antenna unit to the DAS (block 510). In some examples, the test user equipment reports the measured signal power measurements to a master unit or controller of the DAS.

The method 500 proceeds with adjusting one or more components of the remote antenna unit and/or extension unit until the target signal power for the downlink test signals from the remote antenna unit and the extension unit is received at the test user equipment for the particular position (block 512). For optimal MIMO performance, the received signal power of MIMO signals from the remote antenna unit and the extension unit should be approximately the same signal strength. This is usually the case if the test user equipment is a similar distance from the remote antenna unit and the extension unit and both the remote antenna unit and the extension unit transmit at the same power level. Therefore, the target signal power for the comparison is approximately equal for remote antenna unit and the extension unit for a particular position. In some examples, the target signal power of the downlink test signals from the remote antenna unit and the extension unit for the particular position of the test user equipment is obtained from the radio network planning for the DAS.

In some examples, the controller of the DAS adjusts the power amplifier of the remote antenna unit based on the comparison between the measured signal power for the downlink test signals at the test user equipment and the target signal power of the downlink test signals at the particular position. In some examples, the controller of the DAS adjusts a power amplifier or variable attenuator of a unit of the DAS based on the comparison between the measured signal power for the downlink test signals at the test user equipment and the target signal power of the downlink test signals at the particular position. In other examples, a user manually adjusts one or more components of the DAS using a graphical user interface of the DAS or the test user equipment.

In some examples, the DAS or test user equipment compares the measured signal power of the downlink test signals from the remote antenna unit and the extension unit received by the test user equipment to a target signal power for the downlink MIMO signals from the remote antenna unit and the extension unit. In some examples, the controller of the DAS compares the measured signal power of the downlink test signals received by the test user equipment to the desired signal power of the downlink test signals for the particular position of the test user equipment. In other examples, the test user equipment can compare the measured signal power of the downlink test signals at the particular position to the target value of the signal power of the downlink test signals at the particular position. In such examples, the test user equipment can provide the comparison to the DAS for further use.

The method 500 optionally proceeds with verifying the total signal power received by the test user equipment at the particular location from the remote antenna unit and the extension unit (block 514).

Upon completion of the downlink leveling and optimization method 500 for a particular location, uplink leveling and optimization is performed during the walk test. The method for leveling and optimization the uplink of a DAS that includes remote antenna units configured for MIMO operation is effectively the same as the method 400 for leveling and optimization the uplink of a DAS that includes remote antenna units configured for SISO operation. In particular, respective uplink paths for the remote antenna unit and extension unit are operate and adjustments are made to one or more components of the DAS in the uplink paths until the target uplink signal power is received at the POI or master unit for the respective uplink path and the loss/gain on the respective uplink path and a corresponding downlink path between the base station to the test user equipment are the same.

As discussed above, it is common for radio network planning to have a target signal quality for each position in addition to a target signal power for each position for the radio network planning. In some examples, the test user equipment is configured to measure a signal quality (such as, for example, signal-to-noise ratio (SNR), signal-to-interference-plus-noise ratio (SINR), reference signal receive quality (RSRQ), or the like) for the received downlink test signals from remote antenna units of the DAS as well. In such examples, the signal quality is measured and used in a similar manner compared to the signal power. In particular, the test user equipment measures the signal quality of the downlink test signals and a unit of the DAS measures the signal quality of uplink test signals. The test user equipment and/or the unit of the DAS optionally reports the measured signal quality and one or more components of the DAS are adjusted until the target signal quality is received at the test user equipment or unit of the DAS.

### Example Embodiments

Example 1 includes a method for leveling and optimizing a distributed antenna system, comprising: determining a position of a test user equipment; identifying one or more remote antenna units of a plurality of remote antenna units of the distributed antenna system in a vicinity of the test user equipment that contribute to downlink test signals received by the test user equipment at the position; transmitting downlink test signals from each remote antenna unit of the one or more remote antenna units to the test user equipment at the position; measuring a signal power of the downlink test signals transmitted from each remote antenna unit of the one or more remote antenna units received by the test user equipment at the position; and adjusting one or more components of the distributed antenna system until a target signal power of the downlink test signals from each remote antenna unit of the one or more remote antenna units for the position is received at the test user equipment.

Example 2 includes the method of Example 1, further comprising measuring a signal quality of the downlink test signals transmitted from each remote antenna unit of the one or more remote antenna units received by the test user equipment at the position; and adjusting one or more components of the distributed antenna system until a target signal quality of the downlink test signals from each remote antenna unit of the one or more remote antenna units for the position is received at the test user equipment.

Example 3 includes the method of any of Examples 1-2, further comprising closing all downlink paths between the one or more remote antenna units and the test user equipment and then sequentially opening a respective downlink path between a respective remote antenna unit and the test user equipment.

Example 4 includes the method of any of Examples 1-3, further comprising: measuring a total signal power of the downlink test signals from all of the one or more remote antenna units received by the test user equipment; comparing the measured total signal power of the downlink test signals from all of the one or more remote antenna units received by the test user equipment to a target total signal power for the downlink test signals from all of the one or more remote antenna units in a map of the radio network planning for the position of the test user equipment; and adjusting one or more components of the distributed antenna system until the target total signal power of the downlink test signals from all of the one or more remote antenna units for the position is received at the test user equipment.

Example 5 includes the method of any of Examples 1-4, further comprising reporting the measured signal power of the downlink test signals received by the test user equipment to the distributed antenna system.

Example 6 includes the method of Example 5, further comprising reporting a set of predefined locations of the test user equipment, wherein each predefined location is associated with a set of measured signal power values of the downlink test signals of the one or more remote units received by the test user equipment and a target signal power value, wherein the predefined locations of the test user equipment are reported to the distributed antenna system by uploading a file in a suitable file format or by manually entering the set of predefined locations and the corresponding sets of measured signal power values in a graphical user interface application.

Example 7 includes the method of Example 6, wherein adjusting one or more components of the distributed antenna system is performed by a controller of the distributed antenna system or an external computer, wherein the one or more components are adjusted based on improving a root mean square value determined from target signal power of the downlink test signals for the set of predefined locations of the test user equipment and corresponding calculated signal power values, wherein the calculated signal power values are determined from the measured signal power values and a linear relationship between iteratively adjusted distributed antenna component settings and the measured signal power at a specific predefined location.

Example 8 includes the method of any of Examples 5-7, wherein adjusting one or more components of the distributed antenna system until the target signal power of the downlink test signals from each remote antenna unit of the one or more remote antenna units for the position is received at the test user equipment is performed by a controller of the distributed antenna system based on at least one of: a user control signal entered via a graphical user interface of the distributed antenna system; or a user control signal entered via a graphical user interface of the test user equipment.

Example 9 includes the method of any of Examples 1-8, further comprising calculating a downlink path loss from a master unit or point of interface of the distributed antenna system to an antenna socket of a remote antenna unit by subtracting the reported value of the test signal power at the master unit or the point of interface and the measured test signal power at the remote unit antenna socket.

Example 10 includes the method of any of Examples 1-9, further comprising: transmitting uplink test signals, having an initial signal power, from the test user equipment to a unit of the distributed antenna system via each remote antenna unit of the one or more remote antenna units; measuring a signal power of the uplink test signals at the unit of the distributed antenna system; determining a respective uplink path loss for each respective uplink path between the test user equipment and the unit via each remote antenna unit of the one or more remote antenna units by subtracting the measured signal power of the uplink test signals from the initial signal power; and adjusting one or more components of the distributed antenna system until a desired signal power of the uplink test signals is received at the unit of the distributed antenna system and the respective uplink path loss for each respective uplink path between the test user equipment and the unit via each remote antenna unit of the one or more remote antenna units corresponds to a respective downlink path loss for each respective downlink path between the unit and the test user equipment via each remote antenna unit of the one or more remote antenna units.

Example 11 includes the method of Example 10, further comprising calculating an uplink path loss value from an antenna socket of a remote antenna unit to a master unit or point of interface of the distributed antenna system by subtracting the reported value of the test signal power at the master unit or the point of interface from the measured test signal power at the remote unit antenna socket.

Example 12 includes the method of Example 11, further comprising reporting a set of predefined locations of the test user equipment, wherein each predefined location is associated with a set of uplink path loss values, wherein the predefined locations of the test user equipment are reported to the distributed antenna system by uploading a file in a suitable file format or by manually entering the set of predefined locations and the corresponding sets of measured signal power values in a graphical user interface application.

Example 13 includes the method of any of Examples 11-12, wherein the one or more components are adjusted based on improving a root mean square value determined from a set of uplink path loss values from an antenna socket of remote antenna units to a master unit or point of interface of the distributed antenna system and a corresponding set of downlink path loss values from a master unit or point of interface of the distributed antenna system to antenna sockets of remote antenna units.

Example 14 includes the method of any of Examples 9-13, further comprising closing all uplink paths between the test user equipment and the unit of the distributed antenna system and then opening a respective uplink path between the test user equipment and the unit of the distributed antenna system via a respective remote antenna unit of the one or more remote antenna units.

Example 15 includes the method of any of Examples 1-14, wherein the one or more remote antenna units comprise at least two remote antenna units configured to transmit multiple-input-multiple-output signals, the method further comprising: identifying the at least two remote antenna units configured to transmit multiple-input-multiple-output signals in a vicinity of the test user equipment at the position, wherein the target signal power for downlink test signals from each of the at least two remote antenna units is approximately equal when a distance between each of the at least two remote antenna units and the test user equipment is approximately equal.

Example 16 includes the method of any of Examples 1-15, wherein the downlink test signals are generated by a base station, a point of interface, or a master unit of the distributed antenna system.

Example 17 includes the method of any of Examples 1-16, further comprising determining an orientation of the test user equipment.

Example 18 includes a distributed antenna system, comprising: a unit communicatively coupled to a base station; a plurality of remote antenna units communicatively coupled to the unit of the distributed antenna system and located remotely from the unit of the distributed antenna system, wherein the plurality of remote antenna units is configured to transmit and receive wireless signals with user equipment; wherein a controller of the distributed antenna system is configured to: identify one or more remote antenna units of the plurality of remote antenna units in a vicinity of the test user equipment that contribute to received downlink test signals at a particular location of the test user equipment; transmit downlink test signals from each remote antenna unit of the one or more remote antenna units to the test user equipment at the particular location; receive a measured signal power of the downlink test signals from each remote antenna unit of the one or more remote antenna units, wherein the measured signal power of the downlink test signals from each remote antenna unit of the one or more remote antenna units is measured by the test user equipment at the particular location; and adjust one or more components of the distributed antenna system until a target signal power of the downlink test signals from each remote antenna unit of the one or more remote antenna units for the particular location is received at the test user equipment at the particular location.

Example 19 includes the distributed antenna system of Example 18, wherein the controller of the distributed antenna system is further configured to: receive a measured signal quality of the downlink test signals from each remote antenna unit of the one or more remote antenna units, wherein the measured signal quality of the downlink test signals from each remote antenna unit of the one or more remote antenna units is measured by the test user equipment at the particular location; and adjust one or more components of the distributed antenna system until a target signal quality of the downlink test signals from each remote antenna unit of the one or more remote antenna units for the particular location is received at the test user equipment at the particular location.

Example 20 includes the distributed antenna system of any of Examples 18-19, wherein the unit of the distributed antenna system comprises a point of interface or a master unit.

Example 21 includes the distributed antenna system of any of Examples 18-20, wherein the controller of the distributed antenna system is further configured to compare the measured signal power of the downlink test signals from each remote antenna unit of the one or more remote antenna units to the target signal power for the downlink test signals from each remote antenna unit of the one or more remote antenna units, wherein the target signal power for the particular location of the test user equipment is included in a radio network plan.

Example 22 includes the distributed antenna system of any of Examples 18-21, wherein the controller of the distributed antenna system is further configured to receive commands from the test user equipment to adjust one or more components of the distributed antenna system, wherein the commands from the test user equipment are based on a comparison of the measured signal power of the downlink test signals from each remote antenna unit of the one or more remote antenna units to the target signal power for the downlink test signals from each remote antenna unit of the one or more remote antenna units, wherein the target signal power for the particular location of the test user equipment is included in a radio network plan.

Example 23 includes the distributed antenna system of any of Examples 18-22, wherein the controller of the distributed antenna system is further configured to calculate a root mean square value for a set of predefined locations, wherein each predefined location has a target signal power of the downlink test signals and a set of measured downlink signal power levels from each of the remote antenna units.

Example 24 includes the distributed antenna system of any of Examples 18-23, wherein the controller of the distributed antenna system is further configured to: close all downlink paths between the one or more remote antenna units and the test user equipment and then open a respective downlink path between a respective remote antenna unit and the test user equipment; and individually transmit downlink test signals from a single remote antenna unit of the one or more remote antenna units to the test user equipment at a time.

Example 25 includes the distributed antenna system of any of Examples 18-24, wherein the unit of the distributed antenna system is configured to measure a signal power of uplink test signals from the test user equipment, wherein the uplink test signals are transmitted by the test user equipment with an initial signal power; wherein the controller of the distributed antenna system is further configured to: determine a respective uplink path loss for each respective uplink path between the test user equipment and the unit of the distributed antenna system via each remote antenna unit of the one or more remote antenna units by subtracting the measured signal power of the uplink test signals from the initial signal power; and adjust one or more components of the distributed antenna system until a desired signal power of the uplink test signals is received at the unit of the distributed antenna system and the respective uplink path loss for each respective uplink path between the test user equipment and the unit of the distributed antenna system via each remote antenna unit of the one or more remote antenna units corresponds to a respective downlink path loss for each respective downlink path between the unit of the distributed antenna system and the test user equipment via each remote antenna unit of the one or more remote antenna units.

Example 26 includes the distributed antenna system of Example 25, wherein the controller of the distributed antenna system is configured to calculate a root mean square value, wherein each predefined location has a set of measured downlink path loss values from the master unit or point of interface of the distributed antenna system to the an antenna socket of the remote unit antenna and a set of calculated uplink path loss values in distributed antenna system from the remote unit antenna socket to the master unit or point of interface of the distributed antenna system, wherein the calculated uplink path loss values are obtained from measured uplink path loss values in distributed antenna system by a linear relationship.

Example 27 includes the distributed antenna system of any of Examples 18-26, wherein the controller of the distributed antenna system is configured to adjust one or more components of the distributed antenna system based on at least one of: a user manually adjusting a gain or attenuation of a downlink path of the distributed antenna system via a graphical user interface of the distributed antenna system; or a user manually adjusting a gain or attenuation of a downlink path of the distributed antenna system via a graphical user interface of the test user equipment.

Example 28 includes the distributed antenna system of any of Examples 18-27, wherein the one or more remote antenna units comprise at least two remote antenna units configured to transmit multiple-input-multiple-output signals, wherein the controller of the distributed antenna system is configured to identify the at least two remote antenna units configured to transmit multiple-input-multiple-output signals in a vicinity of the test user equipment at the particular location, wherein the target signal power for downlink test signals from each of the at least two remote antenna units is approximately equal when a distance between each of the at least two remote antenna units and the test user equipment is approximately equal.

Example 29 includes a test user equipment for leveling and optimizing uplink paths of a distributed antenna system, comprising: a test signal generator configured to generate uplink test signals having an initial signal power; a transceiver configured to communicate wireless signals with a distributed antenna system; a user interface configured to receive input from a user of the test user equipment; and a processor communicatively coupled to a memory, wherein the processor is configured to: determine a location of the test user equipment; transmit one or more uplink test signals generated by the test signal generator to a unit of the distributed antenna system via one or more remote antenna units of the distributed antenna system in a vicinity of the test user equipment; receive a measured signal power of the uplink test signals measured at the unit of the distributed antenna system; in response to an input at the user interface, send one or more commands to a controller of the distributed antenna system to cause the controller of the distributed antenna system to adjust one or more components of the distributed antenna system until a desired signal power of the uplink test signals is received at the unit of the distributed antenna system.

Example 30 includes the test user equipment of Example 29, wherein the processor is configured to determine a location of the test user equipment based on position data from a Global Navigation Satellite System (GNSS) sensor or movement data from an accelerometer.

Example 31 includes the test user equipment of any of Examples 29-30, wherein the processor is further configured to display the desired signal power of uplink test signals and the measured signal power of the uplink test signals at the unit of the distributed antenna system on a display of the test user equipment.

Example 32 includes the test user equipment of any of Examples 29-31, further comprising a compass, wherein the processor is further configured to determine an orientation of the test user equipment based on orientation data from the compass.

Example 33 includes a test user equipment for leveling and optimizing downlink paths of a distributed antenna system, comprising: a transceiver configured to communicate wireless signals with a distributed antenna system; a measurement receiver configured to determine a signal power and quality of downlink test signals received by the measurement receiver from the distributed antenna system; a user interface configured to receive input from a user of the test user equipment; and a processor communicatively coupled to a memory, wherein the processor is configured to send one or more commands to a controller of the distributed antenna system in response to an input at the user interface, wherein the one or more commands cause the controller to adjust one or more components of the distributed antenna system until a desired signal power and quality of the downlink test signals is received at the test user equipment.

Example 34 includes the test user equipment of Example 33, wherein the test user equipment is configured to receive multiple-input/multiple-output (MIMO) test signals from at least two remote antenna units of the distributed antenna system at the particular location.

Example 35 includes the test user equipment of any of Examples 33-34, wherein the processor is configured to send a set of predefined locations as a file or as a data stream to a controller of the distributed antenna system, each predefined location having an associated set of measured downlink signal power values from one or more of the remote antenna units of the distributed antenna system and an associated set of measured orientation values, each measured orientation value having an associated set of measured downlink signal power values from one or more of the remote antenna units of the distributed antenna system.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A method for leveling and optimizing a distributed antenna system, comprising:
determining a position of a test user equipment;
identifying one or more remote antenna units of a plurality of remote antenna units of the distributed antenna system in a vicinity of the test user equipment that contribute to downlink test signals received by the test user equipment at the position;
transmitting downlink test signals from each remote antenna unit of the one or more remote antenna units to the test user equipment at the position;
measuring a signal power of the downlink test signals transmitted from each remote antenna unit of the one or more remote antenna units received by the test user equipment at the position; and
adjusting one or more components of the distributed antenna system until a target signal power of the downlink test signals from each remote antenna unit of the one or more remote antenna units for the position is received at the test user equipment.

2-4. (canceled)

5. The method of claim 1, further comprising reporting the measured signal power of the downlink test signals received by the test user equipment to the distributed antenna system.

6. The method of claim 5, further comprising reporting a set of predefined locations of the test user equipment, wherein each predefined location is associated with a set of measured signal power values of the downlink test signals of the one or more remote units received by the test user equipment and a target signal power value, wherein the predefined locations of the test user equipment are reported to the distributed antenna system by uploading a file in a suitable file format or by manually entering the set of predefined locations and the corresponding sets of measured signal power values in a graphical user interface application; and
wherein adjusting one or more components of the distributed antenna system is performed by a controller of the distributed antenna system or an external computer, wherein the one or more components are adjusted based on improving a root mean square value determined from target signal power of the downlink test signals for the set of predefined locations of the test user equipment and corresponding calculated signal power values, wherein the calculated signal power values are determined from the measured signal power values and a linear relationship between iteratively adjusted distributed antenna component settings and the measured signal power at a specific predefined location.

7-9. (canceled)

10. The method of claim 1, further comprising:
transmitting uplink test signals, having an initial signal power, from the test user equipment to a unit of the distributed antenna system via each remote antenna unit of the one or more remote antenna units;
measuring a signal power of the uplink test signals at the unit of the distributed antenna system;
determining a respective uplink path loss for each respective uplink path between the test user equipment and the unit via each remote antenna unit of the one or more remote antenna units by subtracting the measured signal power of the uplink test signals from the initial signal power; and
adjusting one or more components of the distributed antenna system until a desired signal power of the uplink test signals is received at the unit of the distributed antenna system and the respective uplink path loss for each respective uplink path between the test user equipment and the unit via each remote antenna unit of the one or more remote antenna units corresponds to a respective downlink path loss for each respective downlink path between the unit and the test user equipment via each remote antenna unit of the one or more remote antenna units.

11. (canceled)

12. The method of claim 10, further comprising:
calculating an uplink path loss value from an antenna socket of a remote antenna unit to a master unit or point of interface of the distributed antenna system by subtracting the reported value of the test signal power at the master unit or the point of interface from the measured test signal power at the remote unit antenna socket and
reporting a set of predefined locations of the test user equipment, wherein each predefined location is associated with a set of uplink path loss values, wherein the predefined locations of the test user equipment are reported to the distributed antenna system by uploading a file in a suitable file format or by manually entering the set of predefined locations and the corresponding sets of measured signal power values in a graphical user interface application.

13. The method of claim 10, further comprising calculating an uplink path loss value from an antenna socket of a remote antenna unit to a master unit or point of interface of the distributed antenna system by subtracting the reported value of the test signal power at the master unit or the point of interface from the measured test signal power at the remote unit antenna socket
wherein the one or more components are adjusted based on improving a root mean square value determined from a set of uplink path loss values from an antenna socket of remote antenna units to a master unit or point of interface of the distributed antenna system and a corresponding set of downlink path loss values from a master unit or point of interface of the distributed antenna system to antenna sockets of remote antenna units.

14. The method of claim 10, further comprising closing all uplink paths between the test user equipment and the unit of the distributed antenna system and then opening a respective uplink path between the test user equipment and the unit of the distributed antenna system via a respective remote antenna unit of the one or more remote antenna units.

15-17. (canceled)

18. A distributed antenna system, comprising:
a unit communicatively coupled to a base station, wherein the unit of the distributed antenna system comprises a point of interface or a master unit;
a plurality of remote antenna units communicatively coupled to the unit of the distributed antenna system and located remotely from the unit of the distributed antenna system, wherein the plurality of remote antenna units is configured to transmit and receive wireless signals with user equipment;
wherein a controller of the distributed antenna system is configured to:
identify one or more remote antenna units of the plurality of remote antenna units in a vicinity of the test user equipment that contribute to received downlink test signals at a particular location of the test user equipment;
transmit downlink test signals from each remote antenna unit of the one or more remote antenna units to the test user equipment at the particular location;
receive a measured signal power of the downlink test signals from each remote antenna unit of the one or more remote antenna units, wherein the measured signal power of the downlink test signals from each remote antenna unit of the one or more remote antenna units is measured by the test user equipment at the particular location; and
adjust one or more components of the distributed antenna system until a target signal power of the downlink test signals from each remote antenna unit of the one or more remote antenna units for the particular location is received at the test user equipment at the particular location.

19. The distributed antenna system of claim 18, wherein the controller of the distributed antenna system is further configured to:
receive a measured signal quality of the downlink test signals from each remote antenna unit of the one or more remote antenna units, wherein the measured signal quality of the downlink test signals from each remote antenna unit of the one or more remote antenna units is measured by the test user equipment at the particular location; and
adjust one or more components of the distributed antenna system until a target signal quality of the downlink test signals from each remote antenna unit of the one or more remote antenna units for the particular location is received at the test user equipment at the particular location.

20. (canceled)

21. The distributed antenna system of claim 18, wherein the controller of the distributed antenna system is further configured to compare the measured signal power of the downlink test signals from each remote antenna unit of the one or more remote antenna units to the target signal power for the downlink test signals from each remote antenna unit of the one or more remote antenna units, wherein the target signal power for the particular location of the test user equipment is included in a radio network plan.

22. The distributed antenna system of claim 18, wherein the controller of the distributed antenna system is further configured to receive commands from the test user equipment to adjust one or more components of the distributed antenna system, wherein the commands from the test user equipment are based on a comparison of the measured signal power of the downlink test signals from each remote antenna unit of the one or more remote antenna units to the target signal power for the downlink test signals from each remote antenna unit of the one or more remote antenna units, wherein the target signal power for the particular location of the test user equipment is included in a radio network plan.

23. The distributed antenna system of claim 18, wherein the controller of the distributed antenna system is further configured to calculate a root mean square for a set of predefined locations, wherein each predefined location has a target signal power of the downlink test signals and a set of measured downlink signal power levels from each of the remote antenna units.

24. The distributed antenna system of claim 18, wherein the controller of the distributed antenna system is further configured to:
close all downlink paths between the one or more remote antenna units and the test user equipment and then open a respective downlink path between a respective remote antenna unit and the test user equipment; and
individually transmit downlink test signals from a single remote antenna unit of the one or more remote antenna units to the test user equipment at a time.

25. The distributed antenna system of claim 18, wherein the unit of the distributed antenna system is configured to measure a signal power of uplink test signals from the test user equipment, wherein the uplink test signals are transmitted by the test user equipment with an initial signal power;
wherein the controller of the distributed antenna system is further configured to:
determine a respective uplink path loss for each respective uplink path between the test user equipment and the unit of the distributed antenna system via each remote antenna unit of the one or more remote antenna units by subtracting the measured signal power of the uplink test signals from the initial signal power; and
adjust one or more components of the distributed antenna system until a desired signal power of the uplink test signals is received at the unit of the distributed antenna system and the respective uplink path loss for each respective uplink path between the test user equipment and the unit of the distributed antenna system via each remote antenna unit of the one or more remote antenna units corresponds to a respective downlink path loss for each respective downlink path between the unit of the distributed antenna system and the test user equipment via each remote antenna unit of the one or more remote antenna units.

26. The distributed antenna system of claim 25, wherein the controller of the distributed antenna system is configured to calculate a root mean square value for a set of predefined locations, wherein each predefined location has a set of measured downlink path loss values from the master unit or point of interface of the distributed antenna system to the an antenna socket of the remote unit antenna and a set of calculated uplink path loss values in distributed antenna system from the remote unit antenna socket to the master unit or point of interface of the distributed antenna system, wherein the calculated uplink path loss values are obtained from measured uplink path loss values in distributed antenna system by a linear relationship.

27. The distributed antenna system of claim 18, wherein the controller of the distributed antenna system is configured to adjust one or more components of the distributed antenna system based on at least one of:
a user manually adjusting a gain or attenuation of a downlink path of the distributed antenna system via a graphical user interface of the distributed antenna system; or
a user manually adjusting a gain or attenuation of a downlink path of the distributed antenna system via a graphical user interface of the test user equipment.

28. The distributed antenna system of claim 18, wherein the one or more remote antenna units comprise at least two remote antenna units configured to transmit multiple-input-multiple-output signals, wherein the controller of the distributed antenna system is configured to identify the at least two remote antenna units configured to transmit multiple-input-multiple-output signals in a vicinity of the test user equipment at the particular location, wherein the target signal power for downlink test signals from each of the at least two remote antenna units is approximately equal when a distance between each of the at least two remote antenna units and the test user equipment is approximately equal.

29-32. (canceled)

33. A test user equipment for leveling and optimizing downlink paths of a distributed antenna system, comprising:
a transceiver configured to communicate wireless signals with a distributed antenna system;
a measurement receiver configured to determine a signal power and quality of downlink test signals received by the measurement receiver from the distributed antenna system;
a user interface configured to receive input from a user of the test user equipment; and
a processor communicatively coupled to a memory, wherein the processor is configured to send one or more commands to a controller of the distributed antenna system in response to an input at the user interface, wherein the one or more commands cause the controller to adjust one or more components of the distributed antenna system until a desired signal power and quality of the downlink test signals is received at the test user equipment.

34. The test user equipment of claim 33, wherein the test user equipment is configured to receive multiple-input/multiple-output (MIMO) test signals from at least two remote antenna units of the distributed antenna system at the particular location.

35. The test user equipment of claim 33, wherein the processor is configured to send a set of predefined locations as a file or as a data stream to a controller of the distributed antenna system, each predefined location having an associated set of measured downlink signal power values from one or more of the remote antenna units of the distributed antenna system and an associated set of measured orientation values, each measured orientation value having an associated set of measured downlink signal power values from one or more of the remote antenna units of the distributed antenna system.
